(19) United States
(12) Patent Application Publication
(10) Pub. No.: US 2025/0307935 A1
(43) Pub. Date: Oct. 2, 2025

(54) SYSTEM AND METHOD FOR DETECTING DRIVER OF VARIANCE

(71) Applicant: JPMorgan Chase Bank, N.A., New York, NY (US)

(72) Inventors: Rohit ANAND, Bangalore (IN); Avinash SHARMA, Bengaluru (IN)

(73) Assignee: JPMorgan Chase Bank, N.A., New York, NY (US)

(21) Appl. No.: 18/663,561

(22) Filed: May 14, 2024

(30) Foreign Application Priority Data
Apr. 1, 2024 (IN) 202411027050

(51) Int. Cl. G06Q 40/06

(52) U.S. Cl. CPC G06Q 40/06

(57) ABSTRACT

A system and method for detecting driver of variance are disclosed. The method includes receiving dependent variable(s) (y) and a set of independent variables (Xₙ). Next, the method includes computing a correlation (Rₓₓ) between at least two of the independent variables and then calculating a partial effect (β) of each of the independent variables on the dependent variable(s) (y). The method includes estimating a row relative weight as a percentage of coefficient of determination R² based on a sum of squared values of the calculated partial effect of the independent variables. The method includes determining a distance from median of x-coordinate (DFM x) and y-coordinate (DFM y) of the set of independent variables. The method includes detecting and displaying at least one driver of variance calculated via a weighted Euclidean distance calculated based on the DFM x and DFM y, and the estimated row relative weight.

### CROSS-REFERENCE TO RELATED APPLICATIONS

This application claims priority benefit from Indian Application No. 202411027050, filed on Apr. 1, 2024 in the India Patent Office, which is hereby incorporated by reference in its entirety.

### BACKGROUND

### Field of the Disclosure

This technology generally relates to the technical field of information processing, and more particularly to methods and systems for detecting driver of variance.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Financial planning is an essential activity in today's ever-changing economic landscape. It allows individuals or companies to allocate their resources optimally, ensuring that they can meet their future goals and aspirations. Various tools and methodologies exist in the financial domain to assist individuals or companies in understanding their financial needs and making informed decisions. Marketing management is also a part of financial planning for big organizations or companies. Marketing teams of big organizations are responsible for marketing management. As a part of their responsibility, these marketing teams are required to produce management reports for a predefined period (such as for every month) where the management reports encompass variable analysis related to marketing expenditures and the identification of the factors that have changed or are driving those expenditures. The variable analysis is a technique which examines the relationship between variables such as dependent and independent variables.

One of the commonly used methods for the variable analysis is relative weights analysis (RWA). RWA is a method of calculating relative importance of predictor variables in contributing to an outcome variable. In general, it is difficult to determine the relative weight of the predicator variable because of non-zero predictor intercorrelations. However, despite considering RWA takes into consideration the unique contribution of each predictor variable and it is combined with other variables, RWA faces challenges in accurately identifying the primary drivers of variance.

At present, marketing teams spend a substantial amount of time in identification of the driver of change or variance by scanning each general ledgers (GL's). Also, marketing teams utilize financial analysis tools such as financial planning software, in order to perform marketing expense analysis or variable analysis. But the conventionally available financial analysis tools often lack the ability to solve issues of multicollinearity while calculating relative weights for the predictor variables, which makes it difficult to determine the individual effect of each independent variable on the dependent variable. As a result, existing methodologies or the financial analysis tools are failed to detect important drivers of variance while performing variable analysis.

Hence, in view of these and other existing limitations, there arises an imperative need to provide an efficient solution to overcome the above-mentioned limitations and to provide a method and system for detecting driver of variances in the process of variable analysis.

### SUMMARY

The present disclosure, through one or more of its various aspects, embodiments, and/or specific features or sub-components, provides, inter alia, various systems, servers, devices, methods, media, programs, and platforms for detecting driver of variance.

According to an aspect of the present disclosure, a method for detecting driver of variance is disclosed. The method is implemented by at least one processor. The method includes receiving, by the at least one processor via a communication interface, at least one dependent variable y and a set of independent variables Xₙ. Next, the method includes computing, by the at least one processor, a correlation Rₓₓ between at least two of the independent variables from the set of independent variables Xₙ. Next, the method includes calculating, by the at least one processor, a partial effect β of each independent variable on the at least one dependent variable y. Next, the method includes estimating, by the at least one processor, a row relative weight as a percentage of coefficient of determination R² based on a sum of squared values of the calculated partial effect (β) of each respective one of the set of independent variables Xₙ. Next the method includes determining, by the at least one processor, a distance from median of x-coordinate DFM x and a distance from median of y-coordinate DFM y of the set of independent variables Xₙ for a plurality of combinations of predefined time periods and scenarios. Next, the method includes detecting, by the at least one processor, at least one driver of variance via a weighted Euclidean distance calculated based on the DFM x, DFM y, and the estimated row relative weight. Next, the method includes displaying, by the at least one processor, the at least one driver of variance via a user interface (UI).

In accordance with an exemplary embodiment, calculating the partial effect β includes computing eigenvectors Q and eigenvalues for the correlation Rₓₓ. Next, the method includes computing a delta Δ by taking a square root of a diagonal matrix of the computed eigenvalues. Next, the method includes computing a lambda matrix Λ by multiplying the eigenvectors Q and a transpose of the delta Δ. Next, the method includes multiplying an inverse of the lambda matrix Λ with a correlation matrix R_{xy}. The correlation matrix R_{xy} is computed from the at least one dependent variable y and the set of independent variables Xₙ.

In accordance with an exemplary embodiment, the method further includes computing, by the at least one processor, a rank for detection of an impact of the at least one driver variance on the at least one dependent variable y. The rank is computed based on the calculated weighted Euclidean distance.

In accordance with an exemplary embodiment, the method further includes standardizing, by the at least one processor, the received at least one dependent variable y and the set of independent variables Xₙ using a standardization technique to have a value of median that is equal to zero and a value of standard deviation that is equal to one (1).

In accordance with an exemplary embodiment, the method further includes displaying, by the at least one processor, the at least one driver of variance in a form of visual representation comprising at least one from among a bar, a chart, a scatter plot, and a graph.

According to another aspect of the present disclosure, a computing device configured to implement an execution of a method for detecting driver of variance is disclosed. The computing device includes a processor; a memory; and a communication interface coupled to each of the processor and the memory. The processor may be configured to receive, via a communication interface, at least one dependent variable y and a set of independent variables Xₙ. Next, the processor may be configured to compute a correlation Rₓₓ between at least two of the independent variables from the set of independent variables Xₙ. Next, the processor may be configured to calculate a partial effect β of each independent variable Xₙ on the at least one dependent variable y. Next, the processor may be configured to estimate a row relative weight as a percentage of coefficient of determination R² based on a sum of squared values of the calculated partial effect β of each respective one of the set of independent variables Xₙ. Next, the processor may be configured to determine a distance from median of x-coordinate DFM x and a distance from median of y-coordinate DFM y of the set of independent variables Xₙ for a plurality of combinations of predefined time periods and scenarios. Next, the processor may be configured to detect at least one driver of variance via a weighted Euclidean distance calculated based on the DFM x, DFM y, and the estimated row relative weight. Next, the processor may be configured to display the at least one driver of variance via a user interface (UI).

In accordance with an exemplary embodiment, the processor may be further configured to perform the calculation of the partial effect β by computing eigenvectors Q and eigenvalues for the correlation Rₓₓ. Next, the processor may be further configured to compute a delta Δ by taking a square root of a diagonal matrix of the computed eigenvalues. Next, the processor may be further configured to compute a lambda matrix Λ by multiplying the eigenvectors Q with a transpose of the delta Δ. Next, the processor may be further configured to multiply an inverse of the lambda matrix Λ with a correlation matrix R_{xy}. The correlation matrix R_{xy} may be computed from the at least one dependent variable y and the set of independent variables Xₙ.

In accordance with an exemplary embodiment, the processor may be further configured to compute a rank for detection of impact of the at least one driver variance on the at least one dependent variable y. The rank may be computed based on the calculated weighted Euclidean distance.

In accordance with an exemplary embodiment, the processor may be further configured to standardize the received at least one dependent variable y and the set of independent variables Xₙ using a standardization technique to have a value of median that is equal to zero and a value of standard deviation that is equal to one (1).

In accordance with an exemplary embodiment, the processor may be further configured to display the at least one driver of variance in a form of visual representation including at least one from among a bar, a chart, a scatter plot, and a graph.

According to yet another aspect of the present disclosure, a non-transitory computer-readable storage medium storing instructions for detecting driver of variance is disclosed. The instructions include executable code which, when executed by a processor, may cause the processor to receive, via a communication interface, at least one dependent variable y and a set of independent variables Xₙ; compute a correlation Rₓₓ between at least two of the independent variables from the set of independent variables Xₙ; calculate a partial effect β of each independent variable on the at least one dependent variable y; estimate a row relative weight as a percentage of coefficient of determination R² based on a sum of squared values of the calculated partial effect β of each respective one of the set of independent variables Xₙ; determine a distance from median of x-coordinate DFM x and a distance from median of y-coordinate DFM y of the set of independent variables Xₙ for a plurality of combinations of predefined time periods and scenarios; detect at least one driver of variance via a weighted Euclidean distance calculated based on the DFM x, DFM y, and the estimated row relative weight; and display the at least one driver of variance via a user interface (UI).

In accordance with an exemplary embodiment, to calculate the partial effect, the executable code when executed may further cause the processor to compute eigenvectors Q and eigenvalues for the correlation Rₓₓ; compute a delta Δ by taking a square root of a diagonal matrix of the computed eigenvalues; compute a lambda matrix Λ by multiplying the eigenvectors Q with a transpose of the delta Δ; and multiply an inverse of the lambda matrix Λ with a correlation matrix R_{xy}, wherein the correlation matrix R_{xy} is computed from the at least one dependent variable y and the set of independent variables Xₙ.

In accordance with an exemplary embodiment, the executable code when executed may further cause the processor to compute a rank for detection of impact of the at least one driver variance on the at least one dependent variable y. In accordance with an exemplary embodiment, the executable code when executed may further cause the processor to compute the rank based on the calculated weighted Euclidean distance.

In accordance with an exemplary embodiment, the executable code when executed may further cause the processor to standardize the received at least one dependent variable y and the set of independent variables Xₙ using a standardization technique to have a value of median that is equal to zero and a value of standard deviation that is equal to one (1).

In accordance with an exemplary embodiment, the executable code when executed may further cause the processor to display the at least one driver of variance in a form of visual representation that includes at least one from among a bar, a chart, a scatter plot, and a graph.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for detecting driver of variance, in accordance with an exemplary embodiment of the present disclosure.

FIG. 2 illustrates an exemplary diagram of a network environment for detecting driver of variance, in accordance with an exemplary embodiment of the present disclosure.

FIG. 3 illustrates an exemplary system for detecting driver of variance, in accordance with an exemplary embodiment of the present disclosure.

FIG. 4 illustrates an exemplary method flow diagram for detecting driver of variance, in accordance with an exemplary embodiment of the present disclosure.

FIG. 5 illustrates a process flow diagram usable for implementing a method for detecting driver of variance, in accordance with an exemplary embodiment of the present disclosure.

FIGS. 6A and 6B illustrate an exemplary chart diagram for displaying driver of variance identified by the method, in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that the present disclosure will be thorough and complete, and will fully convey the scope of the invention to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for detecting driver of variance. The present disclosure receives input data in the form of dependent variable(s) (or referred to as criterion variables) (y) and independent variables (or referred to as predictor variables) (X₀, . . . , Xₙ). The present disclosure automatically identifies driver of changes by performing statistical analysis on the input data. More particularly, the present disclosure first computes a correlation (Rₓₓ) between at least two of the independent variables from the set of independent variables (Xₙ) and then calculates a partial effect (β) of each of the independent variables on the dependent variable(s) (y). Next, the present disclosure estimates a row relative weight as a percentage of coefficient of determination (R²) based on a sum of squared values of the calculated partial effect (β) of the independent variables (Xₙ). Further a distance from median of x-coordinate (DFM x) and a distance from median of y-coordinate (DFM y) of the set of independent variables (Xₙ) is determined for a plurality of combinations of predefined time periods and scenarios. Accordingly, the present disclosure detects at least one driver of variance via a weighted Euclidean distance calculated based on the DFM x, DFM y, and the estimated row relative weight. Finally, the present disclosure allows display of at least one driver of variance via a user interface (UI). Thus, the present disclosure facilitates automatic detection of driver of variance in variance analysis and eliminates the effect of multicollinearity using the features of the present disclosure.

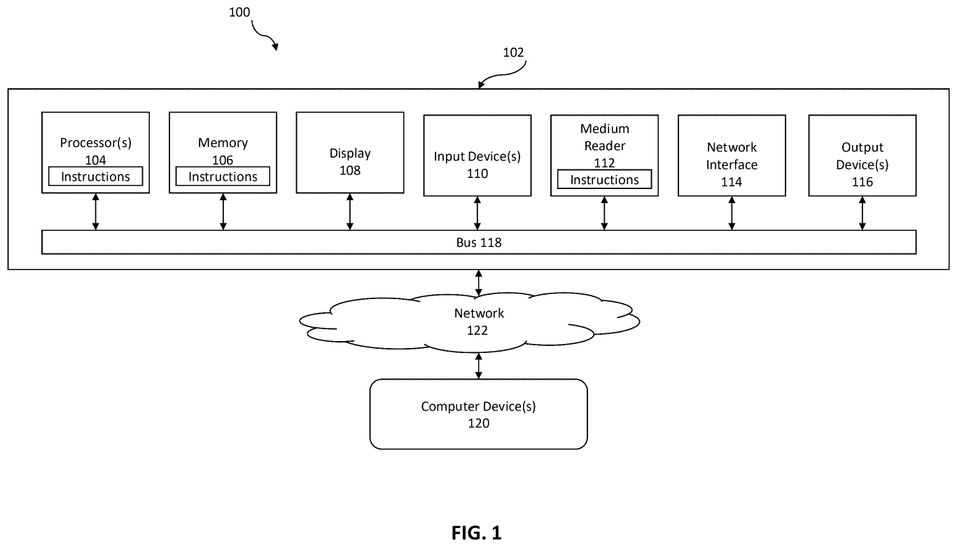

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a micro-controller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for detecting driver of variance.

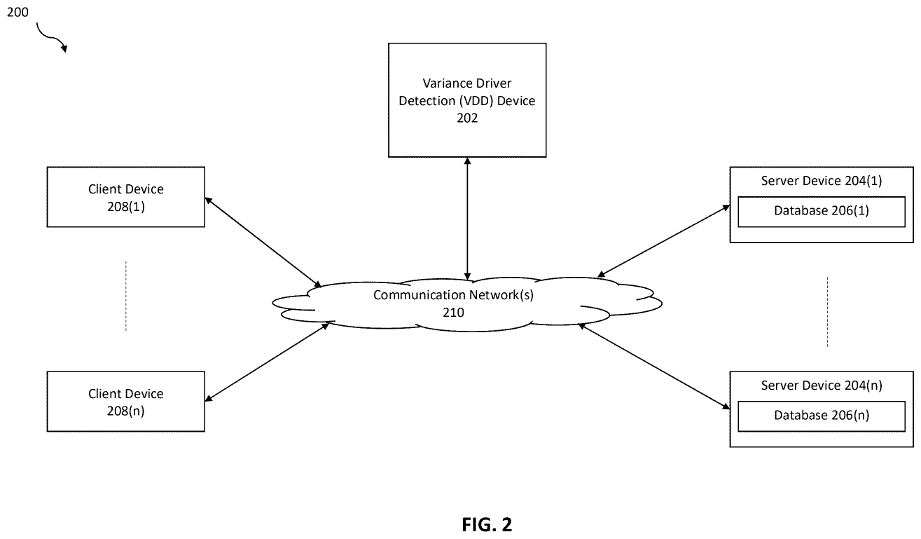

Referring to FIG. 2, a schematic of an exemplary network environment 200 for implementing a method for detecting driver of variance is illustrated. In an exemplary embodiment, the method is executable on any networked computer platform, such as, for example, a personal computer (PC).

The method for detecting driver of variance may be implemented by a variance driver detection (VDD) device 202. The VDD device 202 may be the same or similar to the computer system 102 as described with respect to FIG. 1. The VDD device 202 may store one or more applications that can include executable instructions that, when executed by the VDD device 202, cause the VDD device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the VDD device 202 itself, may be located in the virtual server(s) running in a cloud-based computing environment rather than being tied to one or more specific physical network computing devices. Also, the application(s) may be running in one or more virtual machines (VMs) executing on the VDD device 202. Additionally, in one or more embodiments of this technology, virtual machine(s) running on the VDD device 202 may be managed or supervised by a hypervisor.

In the network environment 200 of FIG. 2, the VDD device 202 is coupled to a plurality of server devices 204(1)-204(n) that hosts a plurality of databases 206(1)-206(n), and also to a plurality of client devices 208(1)-208(n) via communication network(s) 210. A communication interface of the VDD device 202, such as the network interface 114 of the computer system 102 of FIG. 1, operatively couples and communicates between the VDD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VDD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and VDD device 202 that efficiently implement the method for detecting driver of variance.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The VDD device 202 may be a standalone device or integrated with one or more other devices or apparatuses, such as one or more of the server devices 204(1)-204(n), for example. In one particular example, the VDD device 202 may include or be hosted by one of the server devices 204(1)-204(n), and other arrangements are also possible. Moreover, one or more of the devices of the VDD device 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the VDD device 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to detected driver of variance and a set of independent variables (or referred to as predictor variables) (Xₙ) and dependent variables (also referred to as criterion variables) (y). In one implementation, the independent variables may include, but are not limited to, net marketing expense, newsroom, refer a friend premiums, rec event speakers, VFS, port joint marketing fund, marketing execution, retention COE, public relations, paperless marketing, and Disney payments. In one implementation, the dependent variables may include, but are not limited to, expense items such as agency fees acq creative, agency fees creative, Golden State Warriors, media campaign, market research, public relations, credit journey media, freedom media, and ink media port.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the VDD device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the VDD device 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the VDD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VDD device 202, the server devices 204(1)-204(n), or the client devices 208(1)-208(n), for example, may be configured to operate as virtual instances on the same physical machine. In other words, one or more of the VDD devices 202, the server devices 204(1)-204(n), or the client devices 208(1)-208(n) may operate on the same physical device rather than as separate devices communicating through communication network(s) 210. Additionally, there may be more or fewer VDD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

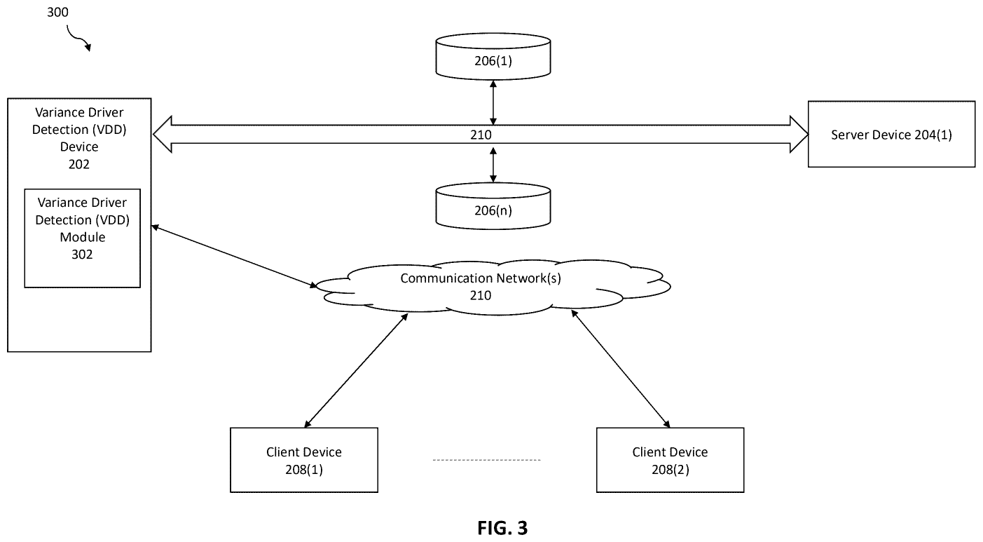

FIG. 3 illustrates an exemplary system for implementing a method for detecting driver of variance, in accordance with an exemplary embodiment. As illustrated in FIG. 3, according to exemplary embodiments, the system 300 may comprise a variance driver detection device (VDD) device 202 including a variance driver detection (VDD) module 302 that may be connected to a server device 204(1) and one or more repositories from the repositories 206(1) . . . 206(n) via a communication network 210, but the disclosure is not limited thereto.

The VDD device 202 is described and shown in FIG. 3 as including the VDD module 302, although it may include other rules, policies, modules, databases, or applications, for example. As will be described below, the VDD module 302 is configured to implement a method for detecting driver of variance.

An exemplary system 300 for implementing a mechanism for detecting driver of variance by utilizing the network environment of FIG. 2 is shown as being executed in FIG. 3. Specifically, a first client device 208(1) and a second client device 208(2) are illustrated as being in communication with VDD device 202. In this regard, the first client device 208(1) and the second client device 208(2) may be “clients” of the VDD device 202 and are described herein as such. Nevertheless, it is to be known and understood that the first client device 208(1) and/or the second client device 208(2) need not necessarily be “clients” of the VDD device 202, or any entity described in association therewith herein. Any additional or alternative relationship may exist between either or both of the first client device 208(1) and the second client device 208(2) and the VDD device 202, or no relationship may exist.

Further, the VDD device 202 is illustrated as being able to access one or more repositories 206(1) . . . 206(n). The VDD module 302 may be configured to access these repositories/databases for implementing a method for detecting driver of variance.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the VDD device 202 via broadband or cellular communication. These embodiments are merely exemplary and are not limiting or exhaustive.

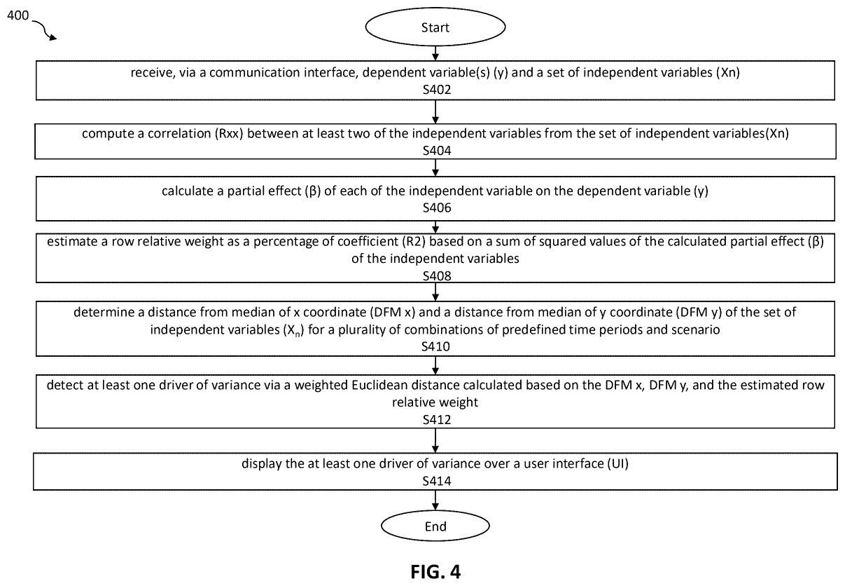

Referring to FIG. 4, an exemplary method 400 is shown for detecting driver of variance, in accordance with an exemplary embodiment. As shown in FIG. 4, the method 400 begins following a need for automatic detection of driver of variance. The method 400 is implemented by at least one processor 104. At step S402, the method 400 includes receiving, by the at least one processor 104 via a communication interface, dependent variable(s) (also referred to herein as criterion variables) (y) and a set of independent variables (also referred to herein as predictor variables) (Xₙ). The Xₙ represents “n” number of independent variables (e.g., X₀, . . . , Xₙ).

As used herein, an independent variable is a variable that is changed in an experiment or study and responsible for causing any change in the dependent variable. The independent variables are also referred to as input or predictor variables.

As used herein, a dependent variable is the variable that is observed or measured in response to changes in the independent variable. It is the outcome variable or the variable of interest.

In an implementation, the received dependent variable(s) (also referred to herein as criterion variables) (y) and the set of independent variables act as input data that may be received from an external source via an input device. In an implementation, the input device may include but is not limited to a mobile, a smartphone, a tablet, a laptop, a portable device or handheld device, a computing device, a computer or personal computer (PC). In an implementation, the external source may include, but is not limited to, a local server, a cloud server, a database, compact flash drives (e.g., USB flash drive and memory card), portable storage devices (e.g., external solid state drive (SSD) and hard disk drive (HDD)), network-attached storage solid state drive (SSD), pen drive, or other memory storage means.

In an exemplary implementation, the independent variables may include nodes or factors responsible for contribution to the dependent variable, such as net marketing expense in a financial domain. The net marketing expense may correspond to the dependent variable. In an exemplary implementation, the independent variables may include newsroom, refer a friend premiums, rec event speakers, port joint marketing fund, marketing execution, public relations, paperless marketing, and Disney payments.

After receiving the dependent variable(s) and the set of independent variables, the method includes the step of standardizing the received dependent variable(s) (y) and the set of independent variables (Xₙ) using a standardization technique to have a value of median that is equal to zero and a value of standard deviation that is equal to one (1). The standardization technique may include use of normalization or scaling technique to transform the received data into a standard based data. In one implementation, the standardization of the independent and dependent variables is performed by using the below equation:

$$value = ( value - median ) / ( p 75 - p 25 )$$

After standardizing the received dependent variable(s) (y) and the set of independent variables (Xₙ), the method includes the step of computing a correlation matrix (e.g., R_{xy}) from one of the dependent (also referred to herein as criterion variables) (y) and the set of independent variables (Xₙ). The correlation matrix (R_{xy}) shows correlation coefficient of the dependent variable (y) with the set of independent variables (Xₙ).

| | y |
|---|---|
| x0 | −0.07858 |
| x1 | 0.550361 |
| x2 | 0.63023 |
| x3 | 0.309661 |
| x4 | −0.0342 |
| x5 | 0.168726 |
| x6 | 0.494875 |
| x7 | 0.054648 |
| x8 | 0.473304 |
| x9 | 0.154193 |
| x10 | 0.195643 |

The above table represents a correlation matrix (R_{xy}) displaying correlation coefficients between the dependent variable (y) with the set of independent variables (Xₙ).

At step S404, the method includes computing, by the at least one processor 104, a correlation (Rₓₓ) between at least two of the independent variables from the set of independent variables (Xₙ). In an exemplary implementation, the method includes computing the correlation (Rₓₓ) between one independent variable with the set of the independent variables (Xₙ). More particularly, the method includes computing the correlation (Rₓₓ) between the dependent variable with each of the independent or predictor variables. In an exemplary embodiment, the below table represents the correlation (Rₓₓ) between the at least two independent variables.

| | x0 | X1 | X2 | X3 | X4 | X5 | X6 | X7 |
|---|---|---|---|---|---|---|---|---|
| x0 | 1 | −0.0764 | −0.4015 | −0.09738 | −0.46706 | 0.355621 | 0.27368 | −0.05254 |
| x1 | −0.0764 | 1 | 0.141298 | 0.087988 | 0.156763 | 0.217959 | 0.21119 | 0.363559 |
| x2 | −0.4015 | 0.141298 | 1 | 0.009972 | −0.21217 | 0.158617 | 0.499802 | −0.37696 |
| x3 | −0.09738 | 0.087988 | 0.009972 | 1 | 0.523785 | 0.021307 | 0.210191 | −0.37017 |
| x4 | −0.46706 | 0.156763 | −0.21217 | 0.523785 | 1 | −0.47991 | −0.50732 | 0.215586 |
| x5 | 0.355621 | 0.217959 | 0.158617 | 0.021307 | −0.47991 | 1 | 0.553819 | −0.0788 |
| x6 | 0.27368 | 0.21119 | 0.499802 | 0.210191 | −0.50732 | 0.553819 | 1 | −0.58351 |
| x7 | −0.05254 | 0.363559 | −0.37696 | −0.37017 | 0.215586 | −0.0788 | −0.58351 | 1 |

The method further includes performing transformation of the independent variables (Xₙ) into a set of orthogonal (uncorrelated) variables that are maximally related to the original independent variables. In an exemplary implementation, the transformation of the independent variables is performed using the below equation:

$${R}_{xx}^{1 / 2} = {Λ}^{*} = Q Δ Q$$

At step S406, the method includes calculating, by the at least one processor 104, a partial effect (β) of each independent variable on the dependent variable (y). In one implementation, calculating the partial effect (β) comprises of steps mentioned as follows: at first, computing eigenvectors (Q) and eigenvalues for the correlation (Rₓₓ). Next, the method includes computing a delta (Δ) by taking a square root of a diagonal matrix of the computed eigenvalues. Next, the method includes computing a lambda matrix (Λ) by multiplying the eigenvectors (Q) with a transpose of the delta (Δ). Next, the method includes multiplying an inverse of the lambda matrix (Λ) with a correlation matrix (R_{xy}), wherein the correlation matrix (R_{xy}) is computed from the dependent variable (y) and the set of independent variables (Xₙ).

As used herein, the terms “eigenvectors” (Q) and “eigenvalues” are the scalar and vector quantities associated with the correlation (Rₓₓ). In an exemplary implementation, the partial effect (β) is calculated by using the below equation:

$${β}^{*} = {R}_{xz}^{- 1} {R}_{xy} = {Λ}^{* - 1} {R}_{xy}$$

R_{xz}⁻¹ represents lambda (Λ) inverse e.g., inverse of multiplying the matrix of eigenvectors and transpose of delta (Δ).

At step S408, the method includes estimating, by the at least one processor 104, a row relative weight as a percentage of coefficient of determination (R²) based on a sum of squared values of the calculated partial effect (β) for each of the independent variables (Xₙ). As used herein, the term “R²” (also referred as R-squared or coefficient of determination) is a statistical measure that determines the proportion of variance in the dependent variable by the independent variable. In an exemplary implementation, the row relative weights for the set of independent variables (Xₙ) (also referred to herein as predictor variables) are provided in a tabular form as given below:

| | Predictor Variables | Relative |
|---|---|---|
| | (Independent Variables) | Weight |
| 0 | Newsroom | 0.304049975 |
| 1 | Refer a Friend Premiums | 0.369189562 |
| 2 | REC Event Speakers | 0.625075275 |
| 3 | VFS | 0.740487174 |
| 4 | Port Joint Marketing Fund | 0.337457014 |
| 5 | Marketing Execution | 0.463850425 |
| 6 | Retention COE | 0.485058961 |
| 7 | Other Acq Prod | 0.33707424 |
| 8 | Public Relations BU | 0.620516034 |
| 9 | Paperless Marketing | 0.400649423 |
| 10 | Disney Payments | 0.45415714 |

Further, the method includes performing standardization of the dependent variable and the set of independent variables (Xₙ) using a standardization technique. In an implementation, the standardization is performed using the below equation:

$$value = ( value - median ) / ( p 75 - p 25 )$$

At step S410, the method includes determining, by the at least one processor 104, a distance from median of x-coordinate (e.g., DFM x) and a distance from median of y-coordinate (e.g., DFM y) of the set of independent variables (Xₙ) for a plurality of combinations of predefined time periods and scenarios. According to an exemplary implementation, the method includes obtaining a distance matrix after performing the standardization procedure. In an implementation, the method includes generation of a variance dataset for a plurality of combination of predefined time periods and scenarios relating to the dependent variables (y) and independent variables (Xₙ). According to an implementation, the method includes calculating a weighted Euclidean distance based on the on the DFM x, DFM y, and the estimated row relative weight. In an exemplary implementation, calculation of the DFM x and DFM y is determined based on the equation provided as follows: DFM x=DFM y=Value−Median.

In one implementation, the variance dataset may include parameters such as but not limited to year, scenario, expense items, time period, QE NM (X and Y), DFM x and DFM y. For example, the variance dataset representing scenario x for year 2023 that includes time period x (for e.g., quarter 3 (Q3)), distance from median X coordinates (DFM x) is shown in the below table:

| | | | Time | | |
|---|---|---|---|---|---|
| | | Expense | Period | QE NM | |
| Year x | Scenario x | Item | x | x | DfM x |
| 2023 | Outlook | Agency Fees | Q3 | 2023Q3 | 5.755 |
| | | Acq | | | |
| | | Creative | | | |
| 2023 | Outlook | Agency Fees | Q3 | 2023Q3 | 5.012 |
| | | Creative | | | |
| 2023 | Outlook | Golden State | Q3 | 2023Q3 | 1.948 |
| | | Warriors | | | |
| 2023 | Outlook | Media | Q3 | 2023Q3 | 0.161 |
| | | Campaign | | | |
| 2023 | Outlook | Market | Q3 | 2023Q3 | 1.664 |
| | | Research | | | |
| 2023 | Outlook | Public | Q3 | 2023Q3 | 1.537 |
| | | Relations | | | |
| | | BU | | | |
| 2023 | Outlook | Credit | Q3 | 2023Q3 | 0.096 |
| | | Journey | | | |
| | | Media | | | |
| 2023 | Outlook | Freedom | Q3 | 2023Q3 | 0.118 |
| | | Media | | | |
| 2023 | Outlook | Ink Media | Q3 | 2023Q3 | 1.308 |
| | | Port | | | |

Similarly, the variance dataset representing scenario y for year 2022 that includes time period y (for e.g., quarter 2 (Q2)), distance from median y coordinates (DFM y) is shown in the below table:

| | | | Time | | |
|---|---|---|---|---|---|
| | Scenario | | Period | QE NM | |
| Year y | y | Expense Item | y | y | DfM y |
| 2022 | Actuals | Agency Fees | Q2 | 2022Q2 | 0.82 |
| | | Acq Creative | | | |
| 2022 | Actuals | Agency Fees | Q2 | 2022Q2 | 0.7 |
| | | Creative | | | |
| 2022 | Actuals | Golden State | Q2 | 2022Q2 | 0 |
| | | Warriors | | | |
| 2022 | Actuals | Media | Q2 | 2022Q2 | 2.193 |
| | | Campaign | | | |
| 2022 | Actuals | Market | Q2 | 2022Q2 | 0.102 |
| | | Research | | | |
| 2022 | Actuals | Public | Q2 | 2022Q2 | 0.325 |
| | | Relations BU | | | |
| 2022 | Actuals | Credit | Q2 | 2022Q2 | 1.577 |
| | | Journey | | | |
| | | Media | | | |
| 2022 | Actuals | Freedom | Q2 | 2022Q2 | 1.27 |
| | | Media | | | |
| 2022 | Actuals | Ink Media | Q2 | 2022Q2 | 0.157 |
| | | Port | | | |

At step S412, the method includes detecting, by the at least one processor 104, at least one driver of variance via the weighted Euclidean distance (WEud) calculated based on the DFM x, DFM y, and the estimated row relative weight (y) for the plurality of combination (e.g., for each of said combination of predefined time period and scenario). In an implementation, the weighted Euclidean distance is calculated by using an equation provided as follows:

$$d ( a , b ) = \sqrt{{\sum }_{i = 1}^{n} {( {w}_{i} \cdot ( {a}_{i} - {b}_{i} ) )}^{2}}$$

According to an exemplary implementation, the calculated weighted Euclidean distance for each of the expense item related to the independent variables and each combination is provided in a table as given below:

| QE NM | Scenario | | DfM | QE NM | DfM | Relative | | |
|---|---|---|---|---|---|---|---|---|
| x | y | Expense Item | x | y | y | weight | WEud | Rank |
| 2023Q3 | Actuals | Agency Fees | 5.755 | 2022Q2 | 0.82 | 0.49547 | 3.4737 | 1 |
| | | Acq Creative | | | | | | |
| 2023Q3 | Actuals | Agency Fees | 5.012 | 2022Q2 | 0.7 | 0.47414 | 2.9691 | 2 |
| | | Creative | | | | | | |
| 2023Q3 | Actuals | Golden State | 1.948 | 2022Q2 | 0 | 0.46948 | 1.3347 | 3 |
| | | Warriors | | | | | | |
| 2023Q3 | Actuals | Media | 0.161 | 2022Q2 | 2.193 | 0.28205 | 1.0792 | 4 |
| | | Campaign | | | | | | |
| 2023Q3 | Actuals | Market | 1.664 | 2022Q2 | 0.102 | 0.46276 | 1.0626 | 5 |
| | | Research | | | | | | |
| 2023Q3 | Actuals | Public | 1.537 | 2022Q2 | 0.325 | 0.62052 | 0.9547 | 6 |
| | | Relations BU | | | | | | |
| 2023Q3 | Actuals | Credit | 0.096 | 2022Q2 | 1.577 | 0.39911 | 0.9356 | 7 |
| | | Journey | | | | | | |
| | | Media | | | | | | |
| 2023Q3 | Actuals | Freedom | 0.118 | 2022Q2 | 1.27 | 0.45857 | 0.7801 | 8 |
| | | Media | | | | | | |
| 2023Q3 | Actuals | Ink Media | 1.308 | 2022Q2 | 0.157 | 0.35891 | 0.6896 | 9 |
| | | Port | | | | | | |

The method further includes computing a rank for detection of impact of the at least one driver variance on the dependent variable (y). The rank is computed based on the calculated weighted Euclidean distance. In an exemplary implementation, the method includes computing ranks for the expense items in a descending order based on the calculated weighted Euclidean distance. For example, in the aforementioned table, WEud 3.4 assigned as rank 1 and WEud 2.969 assigned as rank 2. Thus, the ranking of the expense items helps in detection of major driver of variance or change.

At step S414, the method includes displaying, by the at least one processor 104, the at least one driver of variance over a user interface (UI). In an implementation, the at least one driver of variance is displayed in a form of visual representation comprising at least one from among a bar, a chart, a scatter plot, and a graph. In one implementation, the UI is rendered on the display 510. The UI may be a graphical user interface (GUI).

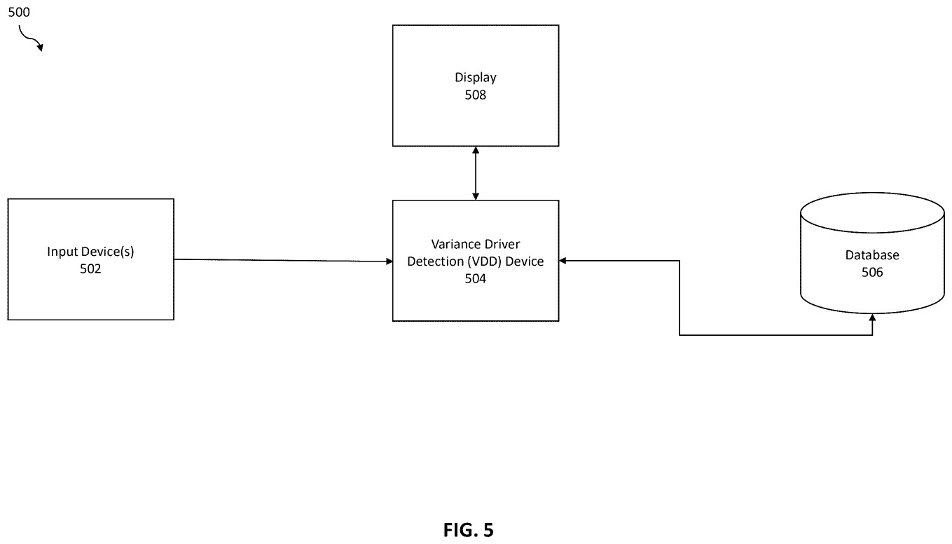

FIG. 5 illustrates a process flow diagram usable for detecting driver of variance, in accordance with an exemplary implementation. As illustrated in FIG. 5, the process flow 500 begins with receiving, by a variance detection device 504, dependent variable(s) (y) and a set of independent variables (Xₙ) which acts as input data. In one implementation, the input data may be received from external sources via an input device 502. This data collection may occur through a secure web interface or application where the user inputs relevant details. The VDD device 504 may also fetch data from external sources, including, for example, a server, database(s) 506 or solid state drive (SSD). The aim is to determine the driver of variance for the given set of dependent and independent variables.

The VDD device 504 is configured to execute method steps including: estimating the contribution of an expense item to the variance of net marketing expense, computing row relative weight, and finally computing rank for detection of impact of the at least one driver variance on the dependent variable (y) based on the calculated weighted Euclidean distance. This way the VDD device 504 determines rank for driver of variances and identifies major driver of changes or variances in the given set of variables.

The VDD device 504 may further display the detected driver of variance over a user interface (UI) of the display 508. The UI may be a graphical user interface (GUI). Hence, the system automates identification of driver of variance in variable analysis and performs variable analysis within a minimal amount of time.

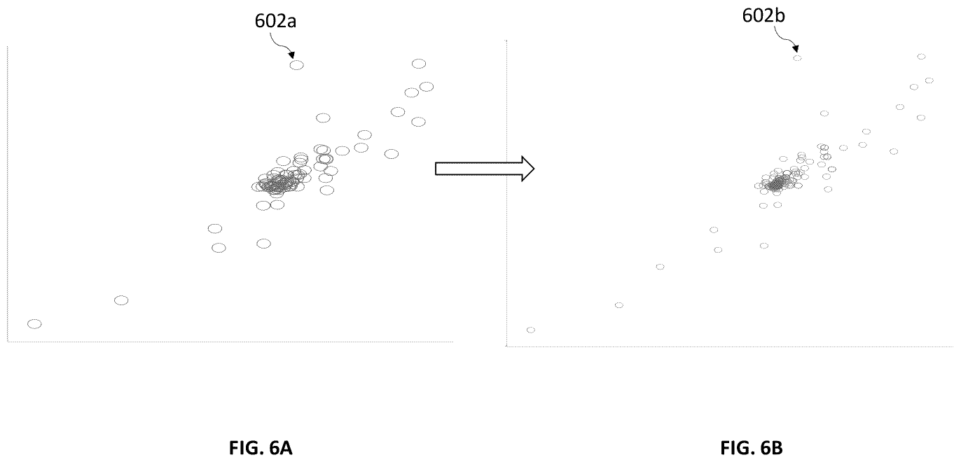

FIG. 6A and FIG. 6B illustrate an exemplary chart diagram for displaying drivers of variances identified by the method, in accordance with an embodiment of the present disclosure. As illustrated in FIG. 6A, each circle 602a represents expense items that contribute to a net marketing expense before passing through the variance detection device (VDD) 202. In an exemplary implementation, the drivers of variance are displayed via a color code and the color code may include colors such as orange, blue, yellow, violet and blue. In one implementation, FIG. 6B represents the same expense items as in FIG. 6A, after passing through the VDD device 202, where each circle in color (such as orange color) 602b represents the drivers identified by the VDD device 202.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for detecting driver of variance is disclosed. The instructions include executable code which, when executed by a processor 104, may cause the processor 104 to receive, by the at least one processor 104 via a communication interface, dependent variable(s) (y) and a set of independent variables (Xₙ); compute a correlation (Rₓₓ) between at least two of the independent variables from the set of independent variables (Xₙ); calculate a partial effect (β) of each of the independent variable (Xₙ) on the dependent variable(s) (y); estimate a row relative weight as a percentage of coefficient of determination (R²) based on a sum of squared values of the partial effect (β) of the independent variables (Xₙ); determine a distance from median of x-coordinate (DFM x) and a distance from median of y-coordinate (DFM y) of the set of independent variables (Xₙ) for a plurality of combinations of predefined time periods and scenarios; detect at least one driver of variance via a weighted Euclidean distance calculated based on the DFM x, DFM y, and the estimated row relative weight; and display the at least one driver of variance via a user interface (UI).

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for detecting driver of variance, the method being implemented by at least one processor, the method comprising:
receiving, by the at least one processor via a communication interface, at least one dependent variable y and a set of independent variables Xₙ;
computing, by the at least one processor, a correlation Rₓₓ between at least two of the independent variables from the set of independent variables Xₙ;
calculating, by the at least one processor, a partial effect β of each independent variable on the at least one dependent variable y;
estimating, by the at least one processor, a row relative weight as a percentage of coefficient of determination R² based on a sum of squared values of the calculated partial effect β of each respective one of the set of independent variables Xₙ;
determining, by the at least one processor, a distance from median of x-coordinate DFM x and a distance from median of y-coordinate DFM y of the set of independent variables Xₙ for a plurality of combinations of predefined time periods and scenarios;
detecting, by the at least one processor, at least one driver of variance via a weighted Euclidean distance calculated based on the DFM x, DFM y, and the estimated row relative weight; and
displaying, by the at least one processor, the at least one driver of variance via a user interface (UI).

2. The method as claimed in claim 1, wherein calculating the partial effect β comprises:
computing eigenvectors Q and eigenvalues for the correlation Rₓₓ;
computing a delta Δ by taking a square root of a diagonal matrix of the computed eigenvalues;
computing a lambda matrix Λ by multiplying the eigenvectors Q with a transpose of the delta Δ; and
multiplying an inverse of the lambda matrix Λ with a correlation matrix R_{xy}, wherein the correlation matrix R_{xy} is computed from the at least one dependent variable (y and the set of independent variables Xₙ.

3. The method as claimed in claim 1, further comprising computing a rank for detection of impact of the at least one driver variance on the at least one dependent variable y, wherein the rank is computed based on the calculated weighted Euclidean distance.

4. The method as claimed in claim 1, further comprising standardizing, by the at least one processor, the received at least one dependent variable y and the set of independent variables Xₙ using a standardization technique to have a value of median that is equal to zero and a value of standard deviation that is equal to one (1).

5. The method as claimed in claim 1, wherein the at least one driver of variance is displayed in a form of visual representation comprising at least one from among a bar, a chart, a scatter plot, and a graph.

6. A computing device configured to implement an execution of a method for detecting driver of variance, the computing device comprising:
a processor;
a memory; and
a communication interface coupled to each of the processor and the memory, wherein the processor is configured to:
receive, via a communication interface, at least one dependent variable y and a set of independent variables Xₙ;
compute a correlation Rₓₓ between at least two of the independent variables from the set of independent variables Xₙ;
calculate a partial effect β of each independent variable on the at least one dependent variable y;
estimate a row relative weight as a percentage of coefficient of determination R² based on a sum of squared values of the calculated partial effect β of each respective one of the set of independent variables Xₙ;
determine a distance from median of x-coordinate DFM x and a distance from median of y-coordinate DFM y of the set of independent variables Xₙ for a plurality of combinations of predefined time periods and scenarios;
detect at least one driver of variance via a weighted Euclidean distance calculated based on the DFM x, DFM y, and the estimated row relative weight; and
display the at least one driver of variance via a user interface (UI).

7. The computing device as claimed in claim 6, wherein the processor is further configured to perform the calculation of the partial effect β by:
computing eigenvectors Q and eigenvalues for the correlation Rₓₓ;
computing a delta Δ by taking a square root of a diagonal matrix of the computed eigenvalues;
computing a lambda matrix Λ by multiplying the eigenvectors Q with a transpose of the delta Δ; and
multiplying an inverse of the lambda matrix Λ with a correlation matrix R_{xy}, wherein the correlation matrix R_{xy} is computed from the at least one dependent variable y and the set of independent variables Xₙ.

8. The computing device as claimed in claim 6, wherein the processor is further configured to compute a rank for detection of impact of the at least one driver variance on the at least one dependent variable y, wherein the rank is computed based on the calculated weighted Euclidean distance.

9. The computing device as claimed in claim 6, wherein the processor is further configured to standardize the received at least one dependent variable y and the set of independent variables Xₙ using a standardization technique to have a value of median that is equal to zero and a value of standard deviation that is equal to one (1).

10. The computing device as claimed in claim 6, wherein the at least one driver of variance is displayed in a form of visual representation comprising at least one from among a bar, a chart, a scatter plot, and a graph.

11. A non-transitory computer readable storage medium storing instructions for detecting driver of variance, the storage medium comprising executable code which, when executed by a processor, causes the processor to:
receive, via a communication interface, at least one dependent variable y and a set of independent variables Xₙ;
compute a correlation Rₓₓ between at least two of the independent variables from the set of independent variables Xₙ;
calculate a partial effect β of each independent variable on the at least one dependent variable y;
estimate a row relative weight as a percentage of coefficient of determination R² based on a sum of squared values of the calculated partial effect β of each respective one of the set of independent variables (Xₙ);
determine a distance from median of x-coordinate DFM x and a distance from median of y-coordinate DFM y of the set of independent variables Xₙ for a plurality of combinations of predefined time periods and scenarios;
detect at least one driver of variance via a weighted Euclidean distance calculated based on the DFM x, DFM y, and the estimated row relative weight; and
display the at least one driver of variance via a user interface (UI).

12. The storage medium as claimed in claim 11, wherein to calculate the partial effect β when executed by the processor, the executable code further causes the processor to:
compute eigenvectors Q and eigenvalues for the correlation Rₓₓ;
compute a delta Δ by taking a square root of a diagonal matrix of the computed eigenvalues;
compute a lambda matrix Λ by multiplying the eigenvectors Q with a transpose of the delta Δ; and
multiply an inverse of the lambda matrix Λ with a correlation matrix R_{xy}, wherein the correlation matrix R_{xy} is computed from the at least one dependent variable y and the set of independent variables Xₙ.

13. The storage medium as claimed in claim 11, wherein when executed by the processor, the executable code further causes the processor to compute a rank for detection of impact of the at least one driver variance on the at least one dependent variable y, wherein the rank is computed based on the calculated weighted Euclidean distance.

14. The storage medium as claimed in claim 11, wherein when executed by the processor, the executable code further causes the processor to standardize the received at least one dependent variable y and the set of independent variables Xₙ using a standardization technique to have a value of median that is equal to zero and a value of standard deviation that is equal to one (1).

15. The storage medium as claimed in claim 11, wherein when executed by the processor, the executable code further causes the processor to display at least one driver of variance in a form of visual representation comprising at least one from among a bar, a chart, a scatter plot, and a graph.
